(19) United States
(12) Patent Application Publication
(10) Pub. No.: US 2016/0176416 A1
(43) Pub. Date: Jun. 23, 2016

(54) STORAGE BIN WITH TRANSPARENT WINDOW

(71) Applicant: SABIC GLOBAL TECHNOLOGIES B.V., Bergen op Zoom (NL)

(72) Inventors: Ashir P. Thakore, Novi, MI (US); Peter Zuber, Pittsfield, MA (US)

(73) Assignee: Sabic Innovative Plastics IP B.V., Bergen op Zoom (NL)

(21) Appl. No.: 14/908,136

(22) PCT Filed: Jul. 30, 2014
(86) PCT No.: PCT/US2014/048821

§ 371 Date: Jan. 28, 2016

Related U.S. Application Data
(60) Provisional application No. 61/860,670, filed on Jul. 31, 2013.

(51) Int. Cl. B61D 37/00; B64D 11/00

(52) U.S. Cl. CPC B61D 37/003; B64D 11/003

(57) ABSTRACT

The present disclosure relates to an overhead storage system that includes a storage volume (140) and an access panel (180) with a transparent window. This permits users to view the storage volume when the access panel is closed. The window is made from a clear polycarbonate material.

### BACKGROUND

The present disclosure relates to a storage system containing a surface of which at least a portion is transparent to allow a passenger to view the interior of the system. More particularly, the present disclosure relates to an overhead storage system which can be used in airplanes or trains, and will be described with reference thereto.

Airplanes and trains include places to keep passenger luggage such as an in an overhead storage bin. Some overhead storage bins generally comprise a shelf that is positioned above the passenger seat, a storage volume on the shelf with an opening facing towards the aisle, and having a hinged lid or door that controls access to the storage volume. The lid can be locked to retain luggage within the shelf during travel. Other overhead storage bins, particularly on larger airplanes, have a floor and walls that surround the storage volume, with one of the walls including a handle and lock for stowing the storage bin.

As more people bring carryon bags onto airplanes or trains, overhead storage space is at a premium. The doors/walls of conventional overhead storage systems are made of an opaque composite structural material, and passengers are unable to see the storage volume when the door is in the closed position. As a result, one cannot tell whether additional luggage could be placed in a given bin without opening the door. It can be common for a later-boarding passenger to have to open the door of multiple storage bins to look for space for their luggage. This takes time, which increases total boarding time and can add to the stressful nature of travel for the passenger, and increases time on the ground for the carrier.

In addition, during travel, luggage can shift position within the storage volume. The opaque doors/walls do not allow passengers to identify the position of luggage in the storage volume when the door is in the closed position. Thus, luggage can fall out of the storage system and create a hazardous condition for nearby passengers.

There is a need for overhead storage systems that can increase safety, increase the speed of passenger boarding/debarking, and reduce the stressful nature of traveling.

### BRIEF DESCRIPTION

The present disclosure relates to an overhead storage system that comprises a storage volume and an access panel for the storage volume. The access panel includes a transparent window that permits the storage volume to be viewed when the access panel is in a stowed position. This allows users to determine whether the storage volume is already occupied or where in the storage volume any luggage is located. Generally, the access panel can be a door into a storage bin, or can be a wall of a storage bin. The transparent window should also have high scratch resistantance, which aids in maintaining visibility through the window.

Disclosed in various embodiments herein is an overhead storage system for a railcar or an aircraft, comprising: an access panel, the access panel having a front surface facing outwardly from a storage volume, a length defined by a first lateral side and an opposite second lateral side, and a height defined by a top edge and a bottom edge; a latch mechanism for securing the overhead storage bin in a closed position, the latch mechanism including a handle positioned on the front surface of the access panel along the top edge or the bottom edge of the access panel; and at least one transparent window on the front surface of the access panel that permits viewing of the storage volume when the access panel is in the closed position, wherein the transparent window includes a cutout portion that engages the latch mechanism at the top edge or the bottom edge of the access panel.

The access panel may have an arcuate profile.

In some embodiments, the at least one transparent window includes a flange on a rear surface of the window that abuts a back surface of the access panel.

The at least one transparent window may include a first side portion, a second side portion, and a bridge portion joining the first and second side portions.

In particular embodiments, the at least one transparent window has a height that is greater than one-half the height of the access panel.

In other embodiments, the at least one transparent window covers substantially the entire front surface of the access panel.

Sometimes, the access panel is made from an opaque material.

In specific embodiments, the at least one transparent window is formed from a polycarbonate polymer composition having a light transmittance of 80% or higher, and a haze of 1% or less, when measured at 2.54 mm thickness according to ASTM D1003.

The access panel can be a door, wherein the storage volume is defined by a plurality of walls. Alternatively, the access panel can be a wall of a storage bin containing the storage volume.

Also disclosed in embodiments herein is an overhead storage system for a railcar or an aircraft, comprising: an access panel, the access panel having a front surface facing outwardly from a storage volume, a length defined by a first lateral side and an opposite second lateral side, and a height defined by a top edge and a bottom edge; a latch mechanism for securing the overhead storage bin in a closed position, the latch mechanism including a handle positioned on the front surface of the access panel along the top edge or the bottom edge of the access panel; and at least one transparent window on the front surface of the access panel that permits viewing of the storage volume when the access panel is in the closed position, wherein a portion of the perimeter of the transparent window extends around the latch mechanism at the top edge or the bottom edge of the access panel.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a cutout perspective view illustrating a first exemplary embodiment of the access panel with at least one transparent window. Here, two transparent windows are present on either side of the latch mechanism.

FIG. 2 is a cutout perspective view illustrating the access panel of FIG. 1 in an open position (left) and a closed or stowed position (right).

FIG. 3 is a cross sectional view of the overhead storage system used with the access panel of FIG. 1.

FIG. 4 is a front view of the front surface of the access panel (i.e. door) for the access panel of FIG. 1.

FIG. 5 is a cross-sectional view of the access panel of FIG. 1, made along the 5-5 line of FIG. 4.

FIG. 6 is a front view of a second exemplary embodiment of the access panel for the overhead storage system of the present disclosure. Here, the transparent window covers substantially the entire front surface of the access panel (other than the latch mechanism).

FIG. 7 is a front view of a third exemplary embodiment of the of the access panel for the overhead storage system of the present disclosure. Here, the transparent window includes a first side portion, a second side portion, and a bridge portion joining the two side portions. The latch mechanism is isolated by the transparent window.

FIG. 8 is a perspective view of a fourth exemplary embodiment of the of the access panel for the overhead storage system of the present disclosure. Here, a bin-type storage system in the closed position is shown. The access panel is one of the walls of the storage bin.

FIG. 9 is a perspective view of the bin-type storage system of FIG. 8 in an open position.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.”

The present disclosure relates to an overhead storage system that includes a storage volume, an access panel, and a latch mechanism. The access panel includes at least one transparent window that provides a passenger with a clear view of the storage volume when the access panel is in a closed position.

Overhead storage systems generally come in one of two types: a shelf system or a bin system. A shelf-type system is seen in FIG. 2 and FIG. 3. The storage system includes a door and a shelf. The door opens outward and upward, and luggage is placed on the shelf. A plurality of walls defines the storage volume. A bin system is seen in FIG. 8 and FIG. 9. Here, the storage system includes a bin formed from a plurality of walls that encloses a storage volume. Luggage is placed in the bin, and the bin can then pivot shut or be translated upwards into a stowed position.

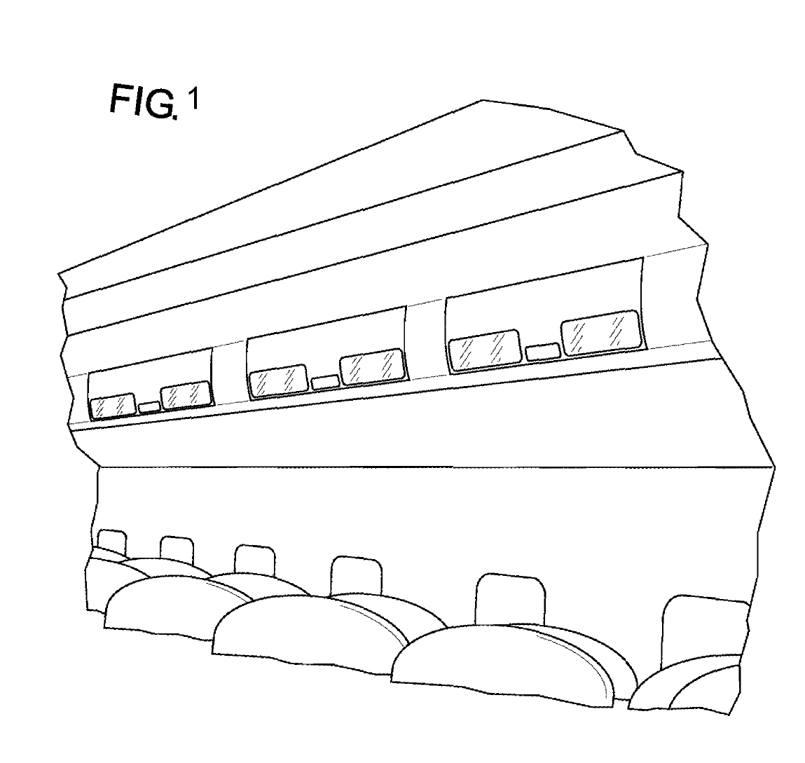

FIGS. 1-3 illustrate a conventional arrangement of overhead storage systems 100 within the passenger compartment 110 of an airplane or a train. The overhead storage systems 100 each include a door 120, shown here in a closed position 150. The door includes a latch mechanism 160 that can be manipulated by a user to open/close the door.

In FIG. 2, the left-side door 120 is shown in an open position 170, which the right-side door is shown in a closed/stowed position 150. The door covers an opening 130 to the storage volume 140 located within the overhead storage system 100. The door has a front surface 122 and a back surface 124, and the latch mechanism 160 is visible on the back surface.

In FIG. 3, the left-side door 120 is shown in an open position, where the door opens outward (from the storage volume 140) and upwards. The opening 130 is also noted.

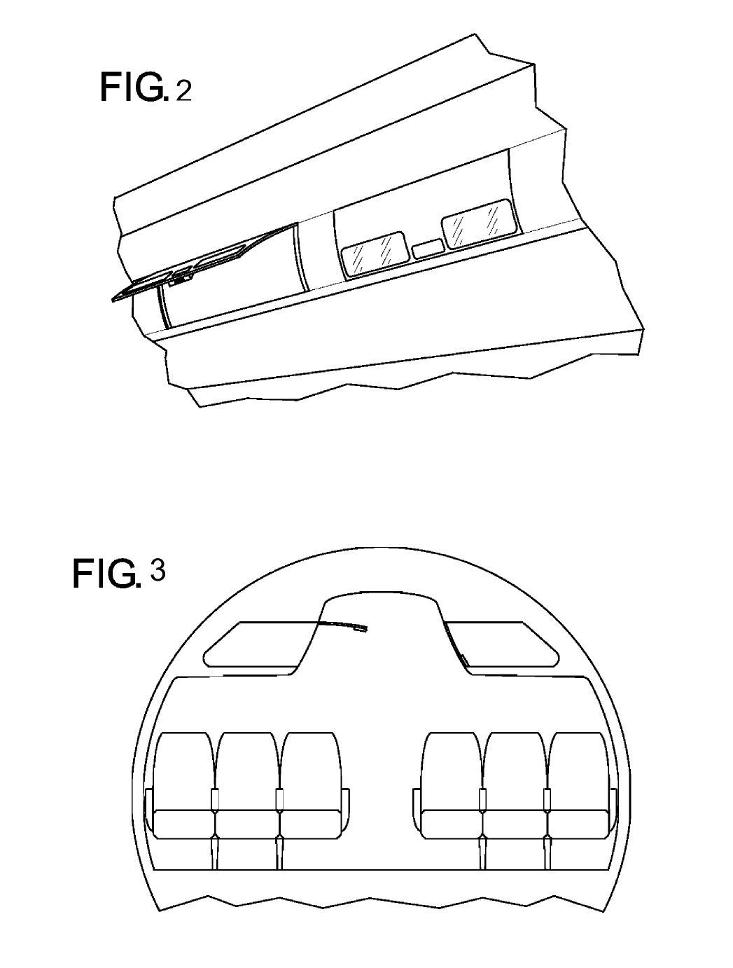

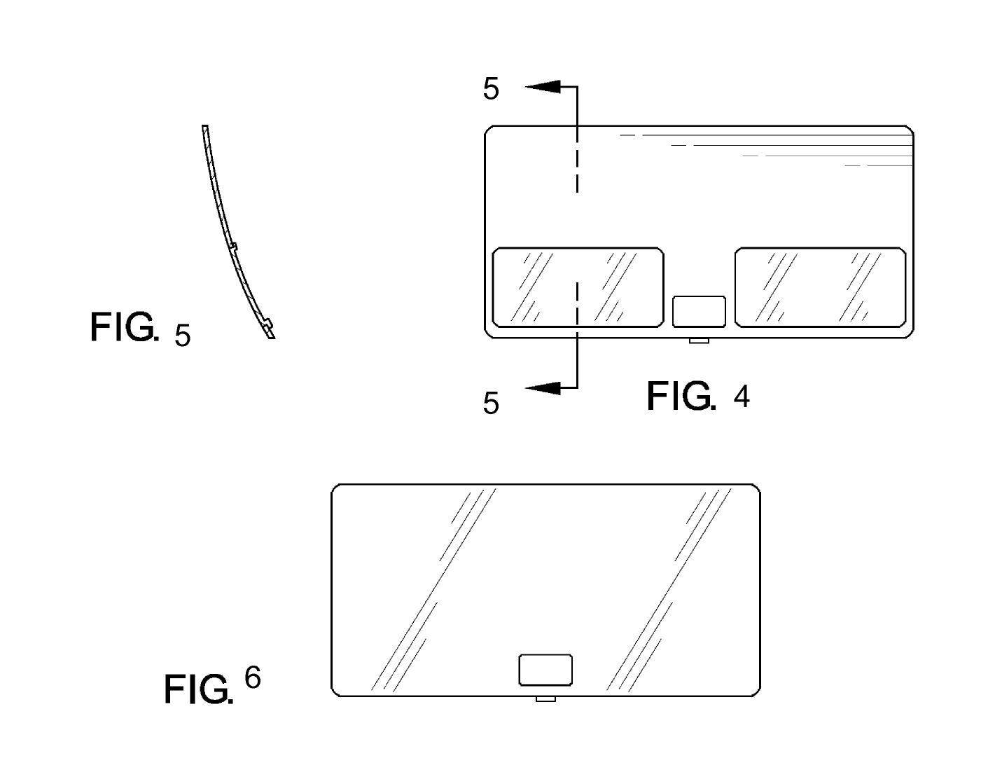

FIG. 4 is a front view of a first exemplary embodiment of the present disclosure. In this first exemplary embodiment, the access panel 180 is a door 120. The door has a front surface 190 which faces outwardly from the storage volume. The access panel 180 includes a first lateral side 200 and an opposite second lateral side 210, the access panel having a length 182 between the two lateral sides. The access panel also includes a top edge 220 and a bottom edge 230, the access panel having a height 184 between these two edges. This access panel is movably attached to the storage volume by a mechanical assembly such as a hinge (not shown here). Two transparent windows 250 are disposed on the front surface 190 on either side of the handle 240. Each window has a rectangular shape with rounded corners. It is contemplated here that the access panel 180 is made from an opaque material that differs from the material used to make the transparent windows.

A latch mechanism is present along the bottom edge of the front surface, and operates to keep the door 120 closed when engaged. The latch mechanism includes a handle 240 positioned on the front surface 190 of the access panel, and a hook 242 that extends from the bottom edge. It is noted that the handle is depicted here as having a rectangular shape, but that the shape is not significant and other shapes for the handle are contemplated. The handle generally provides a mechanism for releasing the hook through a push or pull arrangement.

FIG. 5 is a cross-sectional view along the 5-5 line of FIG. 4. As seen here, the access panel 180 can have a curved or arcuate profile. The access panel has a front surface 190 and a back surface 270. As illustrated, the transparent window 250 includes a flange 260 around the perimeter of the back surface that abuts the back surface 270. This configuration creates a structural connection between the window 250 and the access panel 180, and can prevent objects stored within the storage volume from dislodging the window.

FIG. 6 illustrates a second exemplary embodiment of the access panel 300. Here, the transparent window 250 covers substantially the entire front surface of the access panel. The handle 240 and hook 242 of the latch mechanism are seen along the bottom edge 230. It is contemplated that in this embodiment, the window is made with a cutout portion into which the latch mechanism is fitted. This panel can then be used as a door in a shelf-type overhead storage system when fitted with a hinge along the top edge 220.

FIG. 7 illustrates a third exemplary embodiment of the access panel 400. Here, the access panel includes a front surface 190 with a transparent window. The transparent window 250 has a perimeter 256 that is shaped to extend substantially around the handle 240 of the latch mechanism. The transparent window 250 includes a first side portion 280, a second side portion 282, and a bridge portion 284. The first side portion 280 extends between a first side 244 of the handle and the first lateral side 200. The second side portion 282 extends between a second side 246 of the handle and the second lateral side 210. The two side portions have a rectangular shape. The bridge portion 284 extends from the first side portion 280 to the second side portion 282, and is located above the handle 240. An upper window edge 254 extends between the first lateral side and the second lateral side of the access panel.

As previously discussed, the access panel has a height 184. The transparent window also has a height 252 along the same axis. As depicted here, the height 252 of the window is less than one-half the height 184 of the access panel. In other contemplated embodiments, the height 252 of the window is greater than one-half the height 184 of the access panel.

FIG. 8 illustrates a fourth exemplary embodiment of the access panel 500. Here, the overhead storage system includes a pivot bin, and is shown in the closed position. The system includes a storage bin 570 and a supporting structure 520 for the bin. The access panel 500 is one of the walls of the storage bin 570. The handle 240 is visible on the front surface 190 of the access panel, as is the transparent window 250.

FIG. 9 shows the system in the open position. Here, additional walls 530 of the storage bin are visible, as is the storage volume 540.

The transparent windows of the present disclosure can be clear or have a color or tint as desired to match passenger cabin color schemes. The term “transparent” refers to a material having a light transmittance of 80% or greater, and a haze of 1% or less, when measured at 3.2 mm thickness according to ASTM D1003. It should be recognized that this thickness is used for measurement according to the standard, and should not be construed as limiting the thickness of the transparent window. In further embodiments, the transparent window has a light transmittance of 90% or greater and a haze of 1% or less.

The window material can be made from a polycarbonate polymer composition. Polycarbonates provide the desired combination of transparency with other properties such as impact resistance and scratch resistance. They can also be tuned to meet FST (fire, smoke, toxicity) regulations and the OSU 65/65 heat release standard, as well as other safety regulations (e.g. Federal Aviation Regulation FAR 25.853(d)). For example, the polycarbonate polymer composition may have a peak heat release rate of less than 65 kW/m² measured using the method of FAR 25.4.

As used herein, the terms “polycarbonate” and “polycarbonate polymer” mean compositions having repeating structural carbonate units of the formula (1):

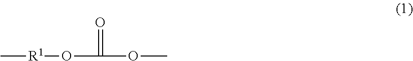

in which at least about 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, wherein R¹ is as defined above. Dihydroxy compounds suitable in an interfacial reaction include dihydroxy compounds of formula (3)

HO-A¹-Y¹-A²-OH (3)

wherein Y¹, A¹ and A² are as described above. Also included are bisphenol compounds of general formula (4):

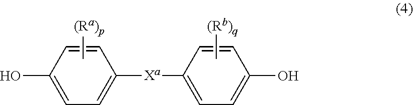

wherein R^{a} and R^{b} each represent a halogen atom or a monovalent hydrocarbon group and may be the same or different; p and q are each independently integers of 0 to 4; and X^{a} represents one of the groups of formula (5):

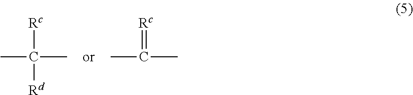

wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

Specific examples of the types of bisphenol compounds that may be represented by formula (3) include 1,1-bis(4-hydroxyphenyl)methane, 1,1-bis(4-hydroxyphenyl)ethane, 2,2-bis(4-hydroxyphenyl)propane (hereinafter “bisphenol-A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, and 1,1-bis(4-hydroxy-t-butylphenyl)propane. Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. All types of polycarbonate end groups are contemplated as being useful in the polycarbonate composition, provided that such end groups do not significantly affect desired properties of the thermoplastic compositions. The branching agents may be added at a level of about 0.05 wt % to about 2.0 wt %.

In particular embodiments, the polycarbonate is a branched polycarbonate that has been branched with from about 0.01 mole % to about 0.5 mole % of a trifunctional phenol, i.e. a compound having one phenol group and at least two other functional groups (which can also be phenol if desired).

The terms “polycarbonate” and “polycarbonate polymer” as used herein further includes blends of polycarbonates with other copolymers comprising carbonate chain units. An exemplary copolymer is a polyester carbonate, also known as a copolyester-polycarbonate. Such copolymers further contain, in addition to recurring carbonate chain units of the formula (1), repeating units of formula (6)

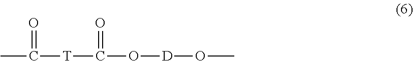

wherein D is a divalent radical derived from a dihydroxy compound, and may be, for example, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T is a divalent radical derived from a dicarboxylic acid, and may be, for example, a C₆₋₂₀ alicyclic radical, a C₆₋₂₀ alkyl aromatic radical, or a C₆₋₂₀ aromatic radical.

In one embodiment, D is derived from an aromatic dihydroxy compound of formula (7):

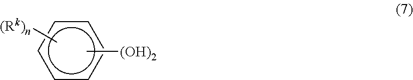

wherein each R^{k} is independently a C₁₋₁₀ hydrocarbon group, and n is 0 to 4. The halogen is usually bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 10:1 to about 0.2:9.8. In another specific embodiment, D is a C₂₋₆ alkylene radical and T is p-phenylene, m-phenylene, naphthalene, a divalent cycloaliphatic radical, or a mixture thereof. This class of polyester includes the poly(alkylene terephthalates).

In other embodiments, poly(alkylene terephthalates) may be used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters. Also contemplated are the above polyesters with a minor amount, e.g., from about 0.5 to about 10 percent by weight, of units derived from an aliphatic diacid and/or an aliphatic polyol to make copolyesters.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexane-dimethanol-1,4-cyclohexanedicarboxylate) (PCCD), having recurring units of formula (8):

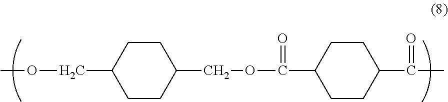

wherein, as described using formula (6), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

Another exemplary copolymer comprises polycarbonate blocks and polydiorganosiloxane blocks, also known as a polycarbonate-polysiloxane copolymer. The polycarbonate blocks in the copolymer comprise repeating structural units of formula (1) as described above, for example wherein R¹ is of formula (2) as described above. These units may be derived from reaction of dihydroxy compounds of formula (3) as described above.

The polydiorganosiloxane blocks comprise repeating structural units of formula (9) (sometimes referred to herein as ‘siloxane’):

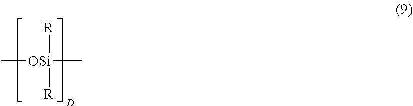

wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer.

The value of D in formula (9) may vary widely depending on the type and relative amount of each component in the thermoplastic composition, the desired properties of the composition, and like considerations. Generally, D may have an average value of 2 to about 1000, specifically about 2 to about 500, more specifically about 5 to about 100. In one embodiment, D has an average value of about 10 to about 75, and in still another embodiment, D has an average value of about 40 to about 60. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

A combination of a first and a second (or more) polycarbonate-polysiloxane copolymers may be used, wherein the average value of D of the first copolymer is less than the average value of D of the second copolymer.

In one embodiment, the polydiorganosiloxane blocks are provided by repeating structural units of formula (10):

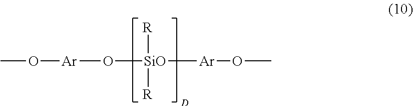

wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (10) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarlyene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds may also be used.

Such units may be derived from the corresponding dihydroxy compound of the following formula (11):

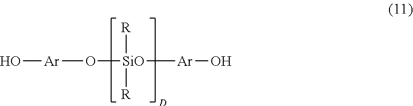

wherein Ar and D are as described above. Such compounds are further described in U.S. Pat. No. 4,746,701 to Kress et al. Compounds of this formula may be obtained by the reaction of a dihydroxyarylene compound with, for example, an alpha, omega-bisacetoxypolydiorangonosiloxane under phase transfer conditions.

In another embodiment the polydiorganosiloxane blocks comprise repeating structural units of formula (12):

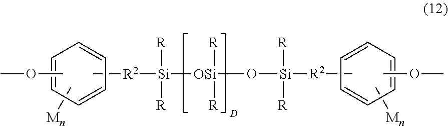

wherein R and D are as defined above. R² in formula (12) is a divalent C₂-C₈ aliphatic group. Each M in formula (12) may be the same or different, and may be cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is an alkyl group such as methyl, ethyl, or propyl, an alkoxy group such as methoxy, ethoxy, or propoxy, or an aryl group such as phenyl, or tolyl; R² is a dimethylene, trimethylene or tetramethylene group; and R is a C₁₋₈ alkyl, haloalkyl such as trifluoropropyl, cyanoalkyl, or aryl such as phenyl or tolyl. In another embodiment, R is methyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (13):

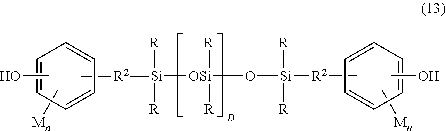

wherein R, D, M, R², and n are as described above.

Such dihydroxy polysiloxanes can be made by effecting a platinum catalyzed addition between a siloxane hydride of the formula (14),

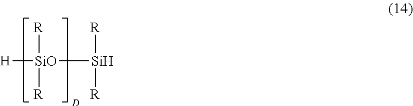

wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-t-butoxyphenol, 4-phenyl-2-phenylphenol, 2-methyl-4-propylphenol, 2-allyl-4,6-dimethylphenol, 2-allyl-6-methoxy-4-methylphenol and 2-allyl-4,6-dimethylphenol. Mixtures comprising at least one of the foregoing may also be used.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformate of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used.

Rather than utilizing the dicarboxylic acid per se, it is possible, and sometimes even desired, to employ the reactive derivatives of the acid, such as the corresponding acid halides, in particular the acid dichlorides and the acid dibromides. Thus, for example, instead of using isophthalic acid, terephthalic acid, or mixtures thereof, it is possible to employ isophthaloyl dichloride, terephthaloyl dichloride, and mixtures thereof.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or a C₆₋₁₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1 to about 10 wt % based on the weight of bisphenol in the phosgenation mixture. In another embodiment an effective amount of phase transfer catalyst may be about 0.5 to about 2 wt % based on the weight of bisphenol in the phosgenation mixture.

A polycarbonate-polysiloxane copolymer may be manufactured by reaction of diphenolic polysiloxane (13) with a carbonate source and a dihydroxy aromatic compound of formula (3), optionally in the presence of a phase transfer catalyst as described above. Suitable conditions are similar to those useful in forming polycarbonates. For example, the copolymers are prepared by phosgenation, at temperatures from below 0° C. to about 100° C., desirably about 25° C. to about 50° C. Since the reaction is exothermic, the rate of phosgene addition may be used to control the reaction temperature. The amount of phosgene required will generally depend upon the amount of the dihydric reactants. Alternatively, the polycarbonate-polysiloxane copolymers may be prepared by co-reacting in a molten state, the dihydroxy monomers and a diaryl carbonate ester, such as diphenyl carbonate, in the presence of a transesterification catalyst as described above. Siloxane groups may also be present at or attached to the ends of the copolymer as well.

In the production of a polycarbonate-polysiloxane copolymer, the amount of dihydroxy polydiorganosiloxane is selected so as to provide the desired amount of polydiorganosiloxane units in the copolymer. The amount of polydiorganosiloxane units may vary widely, i.e., may be about 1 wt % to about 99 wt % of polydimethylsiloxane, or an equivalent molar amount of another polydiorganosiloxane, with the balance being carbonate units. The particular amounts used will therefore be determined depending on desired physical properties of the thermoplastic composition, the value of D (within the range of 2 to about 1000), and the type and relative amount of each component in the thermoplastic composition, including the type and amount of polycarbonate, type and amount of impact modifier, type and amount of polycarbonate-polysiloxane copolymer, and type and amount of any other additives. Suitable amounts of dihydroxy polydiorganosiloxane can be determined by one of ordinary skill in the art without undue experimentation using the guidelines taught herein. For example, the amount of dihydroxy polydiorganosiloxane may be selected so as to produce a copolymer comprising about 1 wt % to about 75 wt %, or about 1 wt % to about 50 wt % polydimethylsiloxane, or an equivalent molar amount of another polydiorganosiloxane. In one embodiment, the copolymer comprises about 5 wt % to about 40 wt %, optionally about 5 wt % to about 25 wt % polydimethylsiloxane, or an equivalent molar amount of another polydiorganosiloxane, with the balance being polycarbonate. In a particular embodiment, the copolymer may comprise about 20 wt % siloxane.

In specific embodiments, the polycarbonate polymer is derived from a dihydroxy compound having the structure of Formula (I):

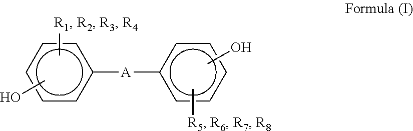

wherein R₁ through R₈ are each independently selected from hydrogen,nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl)propane (i.e. bisphenol-A or BPA). Other illustrative compounds of Formula (I) include: 2,2-bis(4-hydroxy-3-methylphenyl)propane; 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 1,1-bis(4-hydroxyphenyl)cyclohexane; 4,4′dihydroxy-1,1-biphenyl; 4,4′-dihydroxy-3,3′-dimethyl-1,1-biphenyl; 4,4′-dihydroxy-3,3′-dioctyl-1,1-biphenyl; 4,4′-dihydroxydiphenylether; 4,4′-dihydroxydiphenylthioether; 1,3-bis(2-(4-hydroxyphenyl)-2-propyl)benzene; and 1,1-bis(4-hydroxy-3-methylphenyl)cyclohexane (DMBPC).

Certain specific polycarbonate polymers are contemplated for use in the transparent window of the present disclosure. For example, polycarbonate-polysiloxane copolymers may be used. The siloxane blocks may make up from greater than zero to about 25 wt % of the polycarbonate-polysiloxane copolymer, including from 4 wt % to about 25 wt %, from about 4 wt % to about 10 wt %, or from about 15 wt % to about 25 wt %, or from about 6 wt % to about 20 wt %. The polycarbonate blocks may make up from about 75 wt % to less than 100 wt % of the block copolymer, including from about 75 wt % to about 85 wt %. It is specifically contemplated that the polycarbonate-polysiloxane copolymer is a diblock copolymer. The polycarbonate-polysiloxane copolymer may have a weight average molecular weight of from about 28,000 to about 32,000.

Also contemplated are copolyester-polycarbonate copolymers formed from the reaction of bisphenol-A with isophthalic acid, terephthalic acid, and resorcinol (ITR). The copolyester-polycarbonate copolymer may contain from about 20 to about 90 mole percent of carbonate units and from about 5 to about 80 mole percent of ester units formed from the isophthalic acid, terephthalic acid, and resorcinol. The molar ratio of isophthalate to terephthalate may be from about 0.2 to about 4.0, including about 1:1.

Also contemplated are copolymers of a bisphenol monomer and a benzophenone monomer/endcapping agent. Generally speaking, the benzophenone monomer contains a ketone group that is photoactive. When exposed to the appropriate wavelength(s) of light, the ketone group will undergo crosslinking between polymeric strands. This crosslinking increases the chemical resistance, and scratch resistance of the finished product, and also inhibits drip. This permits the use of polymers with relatively lower Mw's but generally better flow properties to be used in molding. Upon irradiation of the molded article, crosslinks can be formed that extend the molecular weight and improve physical properties such as impact strength, tensile strength, flame retardance, or chemical resistance.

Blends of a polycarbonate polymer with other polymers are contemplated. For example, a polycarbonate polymer and a polycarbonate-polysiloxane copolymer can be blended together. Other additives ordinarily incorporated in polycarbonates can also be used, with the proviso that the additives are selected so as to not significantly adversely affect the desired properties of the polycarbonate polymer combination. Combinations of additives can also be used. Such additives can be mixed at a suitable time during the mixing of the components for forming the composition. In embodiments, one or more additives are selected from the following: flame retardants, UV stabilizing additives, thermal stabilizing additives, mold release agents, and gamma-stabilizing agents. Such additives are known in the art.

The polycarbonate compositions of the present disclosure may be molded into pellets. The compositions can then be molded, foamed, or extruded into the desired shape of the transparent window by known methods, such as injection molding, comolding, overmolding, extrusion, rotational molding, blow molding, thermoforming, and vacuum forming. If desired, decorations/aesthetic features can be applied during molding, e.g. a company logo. The transparent window can then be joined together with the remainder of the access panel by heat staking, vibration welding, or other methods known in the art.

It is also contemplated that the transparent window could be formed by sandwiching a light guide between two separate panels. Upon application of light to the light guide, the transparent window could become frosted or display a given message. The transparent window can also be etched with a desired message or logo.

In other contemplated variations, the transparent window can be treated with a coating that increases scratch resistance or other desirable properties. The window could be coated on either surface (the exterior or interior) as desired. For example, it is contemplated that the window (either surface) may have a reflective coating which works in conjunction with a light for the storage volume such that when the light is on, the storage volume is visible through the window but when the light is off, the window reflects light and the storage volume is not visible.

Set forth below are some embodiments of the storage system disclosed herein.

Embodiment 1: An overhead storage system for a railcar or an aircraft, comprising: an access panel, the access panel having a front surface facing outwardly from a storage volume, a length defined by a first lateral side and an opposite second lateral side, and a height defined by a top edge and a bottom edge; a latch mechanism for securing the overhead storage bin in a closed position, the latch mechanism including a handle positioned on the front surface of the access panel along the top edge or the bottom edge of the access panel; and at least one transparent window on the front surface of the access panel that permits viewing of the storage volume when the access panel is in the closed position, wherein the transparent window includes a cutout portion that engages the latch mechanism at the top edge or the bottom edge of the access panel.

Embodiment 2: The storage system of Embodiment 1, wherein the access panel has an arcuate profile.

Embodiment 3: The storage system of any of Embodiments 1-2, wherein the at least one transparent window includes a flange on a rear surface of the window that abuts a back surface of the access panel.

Embodiment 4: The storage system of any of Embodiments 1-3, wherein the at least one transparent window includes a first side portion, a second side portion, and a bridge portion joining the first and second side portions.

Embodiment 5: The storage system of any of Embodiments 1-4, wherein the at least one transparent window has a height that is greater than one-half the height of the access panel.

Embodiment 6: The storage system of any of Embodiments 1-2, wherein the at least one transparent window covers substantially the entire front surface of the access panel.

Embodiment 7: The storage system of any of Embodiments 1-6, wherein the access panel is made from an opaque material.

Embodiment 8: The storage system of any of Embodiments 1-7, wherein the at least one transparent window is formed from a polycarbonate polymer composition having a light transmittance of 80% or higher, and a haze of 1% or less, when measured at 2.54 mm thickness according to ASTM D1003.

Embodiment 9: The storage system of Embodiment 8, wherein the polycarbonate polymer composition contains a polycarbonate-polysiloxane copolymer.

Embodiment 10: The storage system of Embodiment 8, wherein the polycarbonate polymer composition contains a copolyester-polycarbonate copolymer derived from bisphenol-A, isophthalic acid, terephthalic acid, and resorcinol.

Embodiment 11: The storage system of Embodiment 8, wherein the polycarbonate polymer composition contains a copolymer derived from a bisphenol monomer and a benzophenone monomer.

Embodiment 12: The storage system of any of Embodiments 8-11, wherein the polycarbonate polymer composition meets fire, smoke, and toxicity regulations.

Embodiment 13: The storage system of any of Embodiments 8-12, wherein the polycarbonate polymer composition meets the OSU 65/65 heat release standard.

Embodiment 14: The storage system of any of Embodiments 8-13, wherein the polycarbonate polymer composition has a peak heat release rate of less than 65 kW/m².

Embodiment 15: The storage system of any of Embodiments 1-14, wherein the transparent window is formed from a light guide sandwiched between two separate panels.

Embodiment 16: The storage system of any of Embodiments 1-15, wherein the transparent window includes a coating on an exterior surface or an interior surface.

Embodiment 17: The storage system of Embodiment 16, wherein the coating is a reflective coating or a scratch resistant coating.

Embodiment 18: The storage system of any of Embodiments 1-17, wherein the access panel is a door, and the storage volume is defined by a plurality of walls.

Embodiment 19: The storage system of any of Embodiments 1-17, wherein the access panel is a wall of a storage bin containing the storage volume.

Embodiment 20: An overhead storage system for a railcar or an aircraft, comprising: an access panel, the access panel having a front surface facing outwardly from a storage volume, a length defined by a first lateral side and an opposite second lateral side, and a height defined by a top edge and a bottom edge; a latch mechanism for securing the overhead storage bin in a closed position, the latch mechanism including a handle positioned on the front surface of the access panel along the top edge or the bottom edge of the access panel; and at least one transparent window on the front surface of the access panel that permits viewing of the storage volume when the access panel is in the closed position, wherein a portion of the perimeter of the transparent window extends around the latch mechanism at the top edge or the bottom edge of the access panel; wherein the transparent window is made from a polycarbonate polymer composition that meets fire, smoke, and toxicity regulations and meets the OSU 65/65 heat release standard.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. An overhead storage system for a railcar or an aircraft, comprising:
an access panel, the access panel having a front surface facing outwardly from a storage volume, a length defined by a first lateral side and an opposite second lateral side, and a height defined by a top edge and a bottom edge;
a latch mechanism for securing the overhead storage bin in a closed position, the latch mechanism including a handle positioned on the front surface of the access panel along the top edge or the bottom edge of the access panel; and
at least one transparent window on the front surface of the access panel that permits viewing of the storage volume when the access panel is in the closed position, wherein the transparent window includes a cutout portion that engages the latch mechanism at the top edge or the bottom edge of the access panel.

2. The storage system of claim 1, wherein the access panel has an arcuate profile.

3. The storage system of claim 1, wherein the at least one transparent window includes a flange on a rear surface of the window that abuts a back surface of the access panel.

4. The storage system of claim 1, wherein the at least one transparent window includes a first side portion, a second side portion, and a bridge portion joining the first and second side portions.

5. The storage system of claim 1, wherein the at least one transparent window has a height that is greater than one-half the height of the access panel.

6. The storage system of claim 1, wherein the at least one transparent window covers substantially the entire front surface of the access panel.

7. The storage system of claim 1, wherein the access panel is made from an opaque material.

8. The storage system of claim 1, wherein the at least one transparent window is formed from a polycarbonate polymer composition having a light transmittance of 80% or higher, and a haze of 1% or less, when measured at 2.54 mm thickness according to ASTM D1003.

9. The storage system of claim 8, wherein the polycarbonate polymer composition contains a polycarbonate-polysiloxane copolymer.

10. The storage system of claim 8, wherein the polycarbonate polymer composition contains a copolyester-polycarbonate copolymer derived from bisphenol-A, isophthalic acid, terephthalic acid, and resorcinol.

11. The storage system of claim 8, wherein the polycarbonate polymer composition contains a copolymer derived from a bisphenol monomer and a benzophenone monomer.

12. The storage system of claim 8, wherein the polycarbonate polymer composition meets fire, smoke, and toxicity regulations.

13. The storage system of claim 8, wherein the polycarbonate polymer composition meets the OSU 65/65 heat release standard.

14. The storage system of claim 8, wherein the polycarbonate polymer composition has a peak heat release rate of less than 65 kW/m².

15. The storage system of claim 1, wherein the transparent window is formed from a light guide sandwiched between two separate panels.

16. The storage system of claim 1, wherein the transparent window includes a coating on an exterior surface or an interior surface.

17. The storage system of claim 16, wherein the coating is a reflective coating or a scratch resistant coating.

18. The storage system of claim 1, wherein the access panel is a door, and the storage volume is defined by a plurality of walls.

19. The storage system of claim 1, wherein the access panel is a wall of a storage bin containing the storage volume.

20. An overhead storage system for a railcar or an aircraft, comprising:
an access panel, the access panel having a front surface facing outwardly from a storage volume, a length defined by a first lateral side and an opposite second lateral side, and a height defined by a top edge and a bottom edge;
a latch mechanism for securing the overhead storage bin in a closed position, the latch mechanism including a handle positioned on the front surface of the access panel along the top edge or the bottom edge of the access panel; and
at least one transparent window on the front surface of the access panel that permits viewing of the storage volume when the access panel is in the closed position, wherein a portion of the perimeter of the transparent window extends around the latch mechanism at the top edge or the bottom edge of the access panel;
wherein the transparent window is made from a polycarbonate polymer composition that meets fire, smoke, and toxicity regulations and meets the OSU 65/65 heat release standard.
